(19) United States
(12) Patent Application Publication
(10) Pub. No.: US 2020/0220647 A1
(43) Pub. Date: Jul. 9, 2020

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Xiaolin Hou, Beijing (CN)

(73) Assignee: NTT DOCOMO, INC., Tokyo (JP)

(21) Appl. No.: 16/649,026

(22) PCT Filed: Sep. 18, 2018
(86) PCT No.: PCT/JP2018/034527

§ 371 Date: Mar. 19, 2020

(30) Foreign Application Priority Data
Sep. 20, 2017 (JP) 2017-196410

(51) Int. Cl. H04L 1/00; H04W 72/04; H04L 1/18; H04L 5/00; H04W 72/14

(52) U.S. Cl. CPC H04L 1/0013; H04W 72/0413; H04W 72/14; H04L 5/0055; H04L 1/1819

(57) ABSTRACT

The present invention is designed to reduce the decrease in communication throughput and the like in UCI on PUSCH. According to one example of the present disclosure, a user terminal has a receiving section that receives a transmission command for an uplink shared channel, a transmitting section that transmits uplink data and uplink control information in the uplink shared channel, and a control section that exerts control so that a puncturing process and/or a rate matching process is applied to the uplink data based on a timing the transmission command is received.

### TECHNICAL FIELD

The present disclosure relates to a user terminal and a radio communication method in next-generation mobile communication systems.

### BACKGROUND ART

In the Universal Mobile Telecommunications System (UMTS) network, the specifications of long-term evolution (LTE) have been drafted for the purpose of further increasing high speed data rates, providing lower latency and so on (see non-patent literature 1). In addition, the specifications of LTE-Advanced (LTE-A and LTE Rel. 10, 11, 12 and 13) have also been drafted for the purpose of achieving increased capacity and enhancement beyond LTE (LTE Rel. 8 and 9).

Successor systems of LTE are also under study (for example, referred to as “Future Radio Access (FRA),” “5th Generation mobile communication system (5G),” “5G+ (plus),” “New Radio (NR),” “New radio access (NX),” “Future generation radio access (FX),” “LTE Rel. 14, 15 and later versions,” etc.).

In the uplink (UL) of existing LTE systems (for example, LTE Rel. 8 to 13), the DFT-spread-OFDM (DFT-s-OFDM (Discrete Fourier Transform-Spread-Orthogonal Frequency Division Multiplexing)) waveform is supported. Since the DFT-spread-OFDM waveform is a single carrier waveform, it is possible to prevent the peak-to-average power ratio (PAPR) from increasing.

Also, in existing LTE systems (for example, LTE Rel. 8 to 13), a user terminal transmits uplink control information (UCI) by using a UL data channel (for example, Physical Uplink Shared CHannel (PUSCH)) and/or a UL control channel (for example, Physical Uplink Control CHannel (PUCCH)).

The transmission of this UCI is controlled based on whether or not simultaneous transmission of the PUSCH and the PUCCH (simultaneous PUSCH-and-PUCCH transmission) is configured, and whether or not the PUSCH is scheduled in TTIs where the UCI is transmitted.

If the timing for transmitting uplink data (for example, UL-SCH) and the timing for transmitting uplink control information (UCI) overlap, a UE transmits the uplink data and the UCI using an uplink shared channel (PUSCH). Transmission of UCI using PUSCH is also referred to as “UCI on PUSCH.”

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall Description; Stage 2 (Release 8),” April, 2010

### SUMMARY OF INVENTION

### Technical Problem

In future radio communication systems (for example, LTE Rel. 14 or later versions, 5G, NR, etc., which hereinafter will be also simply referred to as “NR”), flexible control of data channels (including DL data channels and/or UL data channels, which will be also referred to simply as “data,” etc.) scheduling has been studied.

For example, studies are in progress to make it possible to change (that is, make variable) the timing and/or the period for transmitting data (hereinafter also referred to as “transmission timing/transmission period”) on a per scheduling basis. Also, studies are underway to make it possible to change the transmission timing/transmission period for delivery acknowledgment signals (also referred to as “HARQ-ACK,” “ACK/NACK,” “A/N,” etc.) in response to data on a per transmission basis.

In NR, it may be likewise possible to transmit uplink data and UCI by using PUSCH, as in existing LTE systems. However, assuming that the timing for transmitting delivery acknowledgment signals in response to data is variable and UL data and UCI are transmitted using PUSCH, what transmission processes should then be applied to them has not been studied much yet. If the same transmission processes as in existing LTE systems are applied, communication throughput, communication quality and so forth may be degraded.

It is therefore an object of the present disclosure to provide a user terminal and a radio communication method, whereby the decline in communication throughput and the like in UCI on PUSCH can be reduced.

### Solution to Problem

According to one aspect of the present disclosure, a user terminal has a receiving section that receives a transmission command for an uplink shared channel, a transmitting section that transmits uplink data and uplink control information in the uplink shared channel, and a control section that exerts control so that a puncturing process and/or a rate matching process is applied to the uplink data based on a timing the transmission command is received.

### Advantageous Effects of Invention

According to one aspect of the present disclosure, it is possible to provide a user terminal and a radio communication method that can reduce the decline in communication throughput and the like in UCI on PUSCH.

### BRIEF DESCRIPTION OF DRAWINGS

FIG. 1 is a diagram to show an example of control of UCI on PUSCH in existing LTE;

FIG. 2 is a diagram to show an example of control of UCI on PUSCH anticipated in NR;

FIG. 3 is a diagram to show examples of HARQ-ACK resources according to an embodiment;

FIG. 4 is a diagram to show an exemplary schematic structure of a radio communication system according to an embodiment;

FIG. 5 is a diagram to show an exemplary overall structure of a radio base station according to an embodiment;

FIG. 6 is a diagram to show an exemplary functional structure of a radio base station according to an embodiment;

FIG. 7 is a diagram to show an exemplary overall structure of a user terminal according to an embodiment;

FIG. 8 is a diagram to show an exemplary functional structure of a user terminal according to an embodiment; and

FIG. 9 is a diagram to show an exemplary hardware structure of a radio base station and a user terminal according to an embodiment.

### DESCRIPTION OF EMBODIMENTS

Envisaging NR, studies are in progress to use a time unit having a variable time length (which may be, for example, at least one of a slot, a minislot and a predetermined number of symbols) as the unit of scheduling for data channels (which include DL data channels and/or UL data channels, and which may be referred to simply as “data” or the like).

Here, a slot is a time unit that depends upon what numerology (for example, the subcarrier spacing and/or the duration of symbols) a UE applies to transmission and/or receipt. The number of symbols per slot may be determined by the subcarrier spacing. For example, if the subcarrier spacing is 15 kHz or 30 kHz, the number of symbols per slot may be seven or fourteen. Meanwhile, when the subcarrier spacing is 60 kHz or greater, the number of symbols per slot may be fourteen.

Subcarrier spacing and the duration of symbols are reciprocal to each other. Therefore, as long as the number of symbols per slot is the same, the higher (wider) the subcarrier spacing, the shorter the length of slots, and the lower (narrower) the subcarrier spacing, the longer the length of slots.

Furthermore, a minislot is a time unit that is shorter than a slot. A minislot may be constituted by fewer symbols (for example, one symbol to “the slot length−1” symbols, and two or three symbols, for example) than a slot. Given a minislot in a slot, the same numerology as that of the slot (for example, the same subcarrier spacing and/or the same symbol duration) may be applied to the minislot, or a different numerology from that of the slot (for example, a higher subcarrier spacing than that of the slot and/or a shorter symbol duration than that of the slot) may be applied to the minislot.

In future radio communication systems where time units that are different from those of existing LTE systems are introduced, it is likely that the transmission and receipt (or allocation) of signals and/or channels are controlled by applying a number of time units to the scheduling of data and the like. When, for example, data and the like are scheduled by using varying time units, multiple data transmission timings/transmission periods may be produced. For example, a user terminal to support a number of time units transmits and receives data that is scheduled in varying time units.

To portray an example, scheduling based on a first time unit (for example, a slot unit) (hereinafter also referred to as “slot-based scheduling”) and scheduling based on a second time unit that is shorter than the first time unit (for example, a non-slot unit) (hereinafter also referred to as “non-slot-based scheduling”) may be used. The “non-slot unit” here may be, for example, a minislot unit, a symbol unit and/or the like. Note that a slot can be constituted by, for example, seven symbols or fourteen symbols, and a minislot can be constituted by one symbol to “the slot length−1” symbols.

In this case, the data transmission timing/transmission period in the time direction varies depending on what data scheduling unit applies. When slot-based scheduling is used, one piece of data may be allocated to one slot. On the other hand, when non-slot-based scheduling is used (for example, when scheduling is made in units of minislots or symbols), data is allocated, selectively, to partial areas in one slot. Therefore, when non-slot-based scheduling is used, it is possible to allocate multiple pieces of data in one slot.

Furthermore, future radio communication systems are anticipated to make it possible to change the transmission timing/transmission period of data and the like on a per scheduling (transmission) basis, in order to control the scheduling of data and the like in a flexible manner. For example, in non-slot-based scheduling, the location to allocate data (for example, PDSCH and/or PUSCH) may start from one symbol every scheduling, and the data may be allocated over a predetermined number of symbols.

Just like the transmission timing/transmission period of data (for example, PDSCH and/or PUSCH) is controlled variably, the UCI (for example, A/N) for this data is also configured so that its transmission timing/transmission period can be changed on a per transmission basis. For example, a base station specifies the transmission timing/transmission period for UCI to a UE by using, for example, downlink control information and/or higher layer signaling. In this case, the timing for transmitting A/N feedback is configured, flexibly, in a period after the downlink control information reporting the transmission timing/transmission period for this A/N, and/or the corresponding PDSCH.

In this way, future radio communication systems are anticipated to configure either the transmission timing/transmission period for A/Ns in response to DL data or the transmission timing/transmission period for PUSCH, or both of these, in a flexible manner. Meanwhile, it is also required, in UL communication, to achieve low Peak-to-Average Power Ratio (PAPR) and/or low inter-modulation distortion (IMD).

As a method of achieving low PAPR and/or low IMD in UL communication, there is a method in which, when UCI transmission and UL data (UL-SCH) transmission occur at the same timing, the UCI and the UL data are multiplexed over PUSCH and transmitted (which is also referred to as “UCI piggyback on PUSCH,” “UCI on PUSCH,” etc.).

In existing LTE systems, when transmitting UL data and UCI (for example, A/N) using PUSCH, the UL data is subjected to a puncturing process, and the UCI is multiplexed over the punctured resources. This is because, in existing LTE systems, the capacity (or the proportion) of UCI that is multiplexed over PUSCH is not much, and/or because it is necessary to prevent the receiving processes in base stations from becoming complex even when DL signal detection failures occur in UEs.

When data is subject to a puncturing process, this means that coding is performed on the assumption that the resources allocated for the data are available for use (or without taking into account the amount of resources unavailable for use), but encoded symbols are not mapped to resources that are not actually available for use (for example, UCI resources) (so as to release the resources). On the receiving side, the encoded symbols of the punctured resources are not used for decoding, so that it is possible to reduce the degradation of characteristics due to puncturing.

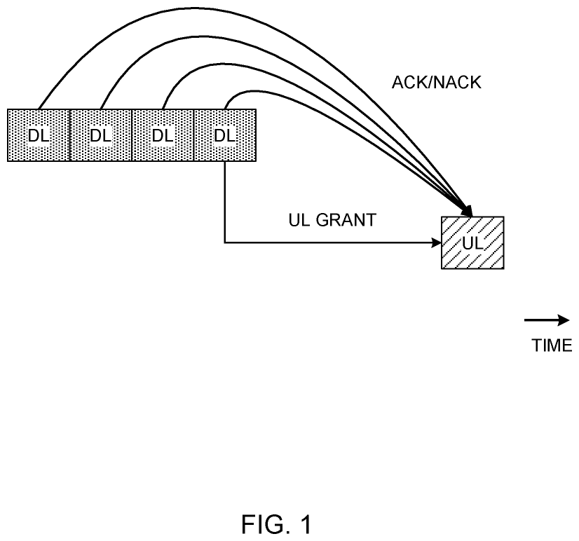

FIG. 1 is a diagram to show an example of control of UCI on PUSCH in existing LTE. In this example, the parts where “DL” or “UL” is shown indicate predetermined resources (for example, time/frequency resources), and the duration of each part corresponds to arbitrary time units (for example, one or more slots, minislots, symbols, subframes, etc.). The same applies to the following examples.

In the case of FIG. 1, a UE transmits ACKs/NACKs in response to the illustrated four DL resources using a UL resource indicated by a predetermined UL grant. In existing LTE, this UL grant is always reported at the last timing of a HARQ-ACK bundling window or at a later timing.

Here, the HARQ-ACK bundling window may be referred to as an “HARQ-ACK feedback window,” or may be referred to simply as a “bundling window” or the like, and corresponds to a period in which A/N feedback is transmitted at the same timing. For example, a UE judges that a certain duration from a DL resource indicated by a predetermined DL assignment is a bundling window, and generates A/N bits corresponding to the window, and controls the feedback.

In future radio communication systems, UCI on PUSCH may be employed as in existing LTE systems.

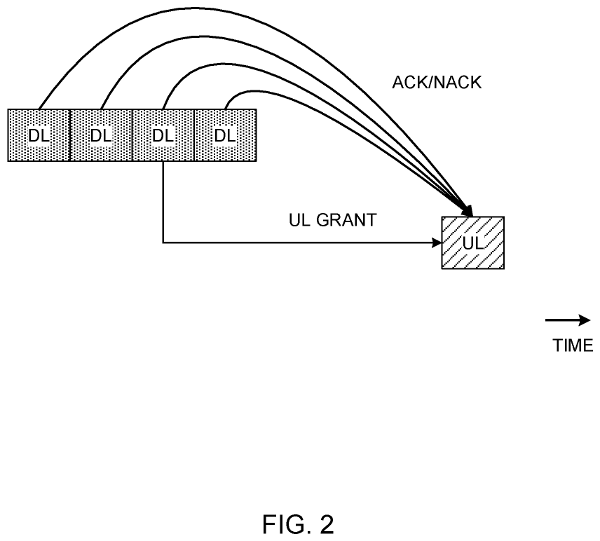

FIG. 2 is a diagram to show an example of control of UCI on PUSCH anticipated in NR. FIG. 2 is similar to FIG. 1, except that DL data included in the bundling window is still scheduled after the UL grant is reported. In this way, NR is under study so as to report a UL grant for HARQ-ACK transmission before the last timing of a bundling window.

However, assuming the case in which, as in FIG. 2, UL data and UCI (for example, A/N) are transmitted using PUSCH, what kind of transmission processes should then be applied to the UL data, UCI and so forth has not been studied much yet. If UCI on PUSCH is applied as in existing LTE systems on the assumption that the transmission timing/transmission period of data and/or UCI are configured on a fixed basis, this might lead to a degradation of communication throughput, communication quality and so forth may be degraded.

So, the present inventors have focused on the fact that, when UL data and UCI are transmitted using PUSCH, a rate-matching process can be applied to the UL data, and come up with the idea of combining a puncturing process and a rate matching process for use.

When data is subjected to a rate matching process, this means that the number of bits after coding (encoded bits) is controlled by taking into account the radio resources that are actually available for use. When the number of encoded bits is smaller than the number of bits that can be mapped to the radio resources that are actually available for use, at least part of the encoded bits may be repeated. When the number of encoded bits is greater than the number of bits that can be mapped, part of the encoded bits may be deleted.

By performing the rate matching process on UL data, which resources are actually available for use is taken into account, and therefore coding can be performed so that the coding rate is higher (shows higher performance) than when the puncturing process is used. It then follows that, for example, by applying the rate matching process instead of the puncturing process when the payload size of UCI is large, it becomes possible to generate UL signals with higher quality, so that the quality of communication quality can be improved.

Now, embodiments of the present invention will be described below in detail. Note that UCI may include at least one of a scheduling request (SR), delivery acknowledgement information (also referred to as “HARQ-ACK (Hybrid Automatic Repeat reQuest-ACKnowledgement),” “ACK” or “NACK (Negative ACK),” “A/N,” and so on) in response to a DL data channel (for example, Physical Downlink Shared CHannel (PDSCH)), channel state information (Channel State Information (CSI)), beam index information (Beam Index (BI)), and a buffer status report (BSR).

In the following embodiments, an HARQ-ACK may be replaced with UCI, or may be replaced with another type of UCI, such as SR, CSI and the like.

Note that, when data is subjected to a rate matching process, this may be read to mean that a data channel (for example, PUSCH) is subjected to a rate matching process. Also, when data is subjected to a puncturing process, this may be read to mean that a data channel is subjected to a puncturing process.

(Radio Communication Method)

In accordance with one embodiment, when there is DL data received before a UL grant, a UE transmits HARQ-ACK based on rate matching (by applying rate matching to the UL resources indicated by the UL grant). UL resources that are subject to rate matching may be referred to as “rate-matched resources,” “rate-matching resources,” and so on.

In accordance with one embodiment, when there is DL data received after a UL grant, the UE transmits HARQ-ACK based on puncturing (by applying puncturing to the UL resources indicated by the UL grant). UL resources that are subject to puncturing may be referred to as “punctured resources,” “puncturing resources,” and so on.

Note that, when DL data is received at the same time with a UL grant, the UE may transmit HARQ-ACK based on rate matching or puncturing.

Also, the basis for deciding whether to transmit HARQ-ACK based on rate matching or based on puncturing does not depend only upon the timing (receiving timing) of the UL grant. For example, the timing where a UL grant's timing is shifted forward or backward through X (X>0) time units (for example, slots) may serve as the above basis. Furthermore, the above basis may be the transmission time interval (TTI) boundary immediately before or after the timing of a UL grant, or may be the timing where this TTI boundary is further shifted forward or backward through X (X>0) time units (for example, slots).

According to this configuration, it is possible to cope with the transmission of HARQ-ACK that allows no extra processing time (when HARQ-ACK is transmitted in response to DL data following the receipt of a UL grant) by applying puncturing. In addition, when HARQ-ACK to allow extra processing time is transmitted (when HARQ-ACK is transmitted in response to DL data preceding the receipt of a UL grant), the quality of communication can be emphasized by applying rate matching. Therefore, UCI can be transmitted at appropriate timings while reducing the decline in communication throughput.

<Resource>

The above two HARQ-ACK transmissions may use separate resources. Rate matching resources and puncturing resources may be selected without overlap. The UE may be configured with candidate rate matching resources, candidate puncturing resources (for example, time and/or frequency resources, periods, offsets) and so forth, from a gNB.

Information about these candidates may be reported (configured) from the gNB to the UE by higher layer signaling (for example, radio resource control (RRC) signaling, broadcast information (the master information block (MIB),system information blocks (SIBs), etc.), medium access control (MAC) signaling, etc.), physical layer signaling (for example, downlink control information (DCI)), or a combination of these, or may be defined in the specification.

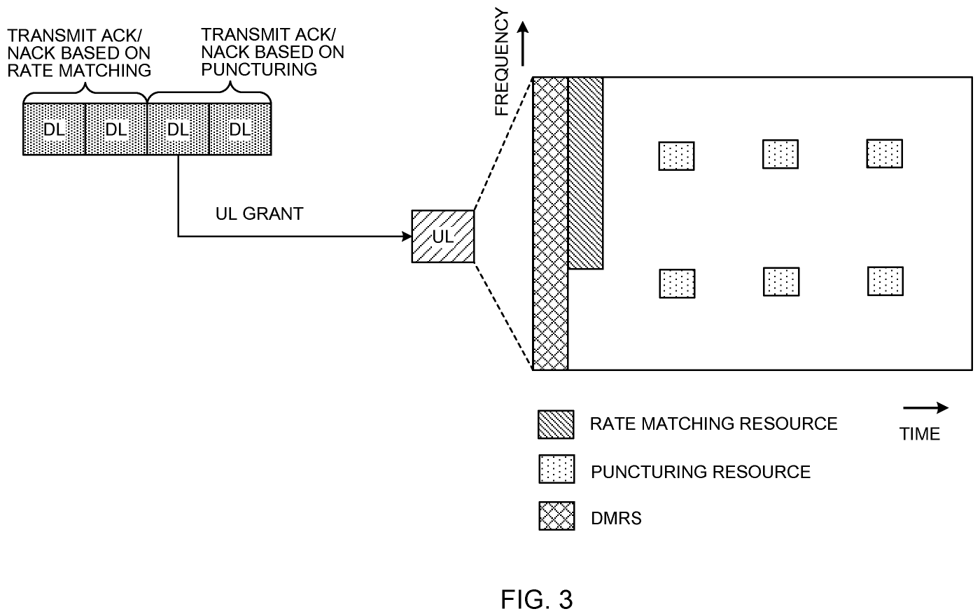

FIG. 3 is a diagram to show examples of HARQ-ACK resources according to an embodiment. In FIG. 3, similar to FIG. 2, four DL resources are illustrated, and the UE receives a UL grant at the timing of the third one. In this case, the UE transmits the HARQ-ACKs in response to the first and second DL resources, which precede the UL grant received, by using rate matching resources. In this case, the UE transmits the HARQ-ACKs in response to the third and fourth DL resources, which follow the UL grant received, by using puncturing resources.

In FIG. 3, the rate matching resources and the puncturing resources are configured without overlap. The rate matching resources may be included in one or more symbols that are the same as or immediately after the DMRS symbol. The rate matching resources and the puncturing resources may be allocated discretely or contiguously. Note that the location of each resource is not limited to the example of FIG. 3.

<Mapping Pattern>

The above two HARQ-ACK transmissions may use separate mapping patterns (which may be referred to as “RE patterns,” “resource patterns,” etc.). The UE may determine the respective mapping patterns for the rate matching resources and the puncturing resources separately.

Information about these mapping patterns may be reported (configured) from the gNB to the UE by higher layer signaling (for example, RRC signaling, broadcast information, etc.), physical layer signaling (for example, DCI) or a combination of these, or may be defined in the specification.

A UL grant may report information about the rate matching and/or puncturing of UL data. Based on the information indicated by the UL grant, the UE determines the UL data's rate matching pattern (the amount of resources, RE locations, etc.).

This rate matching pattern may change depending on the number of HARQ-ACK bits (the amount of information) (may be associated with the number of HARQ-ACK bits). The UE may determine the rate matching pattern based on the number of HARQ-ACK bits. According to this configuration, rate matching can be performed properly depending on the actual number of HARQ-ACK bits.

This rate matching pattern does not have to rely upon the number of HARQ-ACK bits. The UE may determine the rate matching pattern without regard to the number of HARQ-ACK bits. In the latter case, even if the UE fails to detect DL data-scheduling DCI (UL grant), the impact can be reduced.

Note that, when the rate matching pattern does not rely upon the number of HARQ-ACK bits, the UE may map HARQ-ACKs to the HARQ-ACK REs specified by the rate matching pattern obtained from the UL grant. Furthermore, coding may be performed using at least one of repetition code, block code, polar code and the like, and the obtained code may be mapped to the REs. This is particularly suitable when sufficient resources (REs) are available.

Note that the rate matching pattern according to the present embodiment may be replaced with the puncturing pattern for UL data.

<PUCCH>

If DL data comes after a UL grant, the PUSCH may be dropped entirely, instead of puncturing part of the PUSCH, and PUCCH (for example, the PUCCH of the same timing as the PUSCH that is dropped) may be transmitted. Note that, if, for example, the UE is capable of simultaneous PUSCH-and-PUCCH transmission, the UE may transmit HARQ-ACK for the DL data preceding the UL grant on the PUSCH, and transmit HARQ-ACK for the DL data following the UL grant on the PUCCH, or the UE may operate the other way around.

<β_{Offset}>

In existing LTE, UCI resources are controlled based on the value of β_{Offset}. Here, one value for β_{Offset} is configured, semi-statically, for each UCI type (HARQ-ACK, CSI, etc.). β_{Offset} may be referred to as “information about UCI resources.”

Now, according to the embodiment of the present disclosure, β_{Offset} may be set to a common value for both of puncturing and rate matching. That is, regardless of whether puncturing UCI resources or rate matching UCI resources are concerned, the UE may determine the number of REs for mapping HARQ-ACK based on common β_{Offset} values.

The UE determines the number of REs for mapping HARQ-ACK based on the number of HARQ-ACK bits to which rate matching is applied and a single β_{Offset} value. Furthermore, the UE determines the number of REs for mapping HARQ-ACK based on the number of HARQ-ACK bits to puncture and the above single β_{Offset} value.

The common β_{Offset} value may be reported (configured) from the gNB to the UE by higher layer signaling (for example, RRC signaling, broadcast information, etc.), physical layer signaling (for example, DCI) or a combination of these, or may be defined in the specification.

According to this configuration, it is possible to reduce the signaling overhead related to the reporting of β_{Offset}.

Furthermore, according to an embodiment, different β_{Offset} values may be applied between puncturing and rate matching. That is, the UE may determine, for puncturing UCI resources and rate matching UCI resources, respectively, the number of REs for mapping HARQ-ACK based on separate β_{Offset} values.

In this case, it is possible to properly control the coding rate of HARQ-ACK and the impact of puncturing/rate matching on UL data. That is, the number of REs for mapping HARQ-ACK is determined based on the number of HARQ-ACK bits to which rate matching is applied and the first β_{Offset} value. Furthermore, the number of REs for mapping HARQ-ACK is determined based on the number of HARQ-ACK bits to puncture and the second β_{Offset} value. The candidate values that may be configured as the first β_{Offset} and the second β_{Offset} may be common or different.

The first β_{Offset} value and the second β_{Offset} value may be reported (configured) from the gNB to the UE by higher layer signaling (for example, RRC signaling, broadcast information, etc.), physical layer signaling (for example, DCI) or a combination of these, or may be defined in the specification.

According to the embodiment described above, it is possible to control UCI transmission in UCI on PUSCH properly.

(Radio Communication System)

Now, the structure of a radio communication system according to an embodiment will be described below. In this radio communication system, communication is performed using at least one of the above examples or a combination of them.

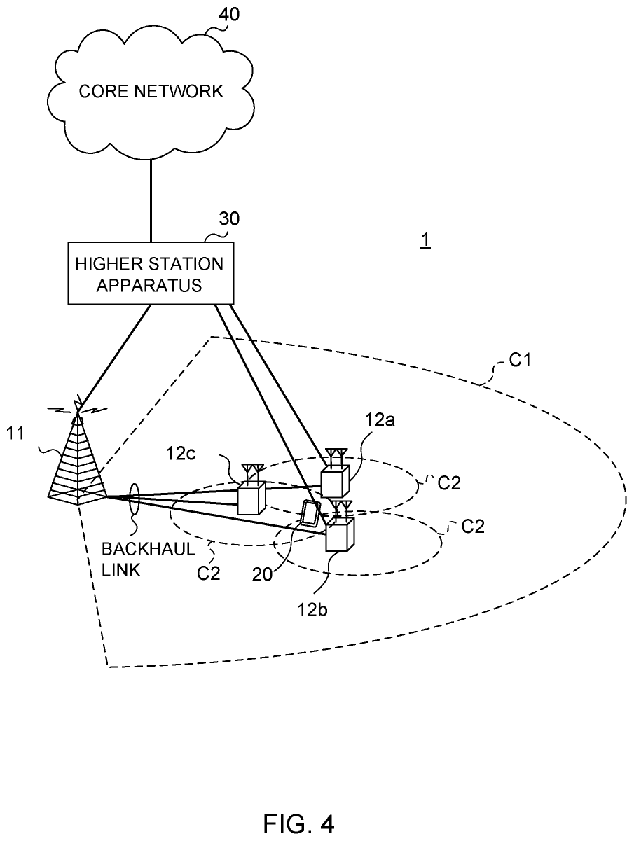

FIG. 4 is a diagram to show an exemplary schematic structure of a radio communication system according to an embodiment. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes one unit.

Note that the radio communication system 1 may be referred to as “Long-term evolution (LTE),” “LTE-Advanced (LTE-A),” “LTE-Beyond (LTE-B),” “SUPER 3G,” “IMT-Advanced,” “4th generation mobile communication system (4G),” “5th generation mobile communication system (5G),” “New Radio (NR),” “Future Radio Access (FRA),” “New-RAT (Radio Access Technology),” and so on, or may be seen as a system to implement these.

The radio communication system 1 includes a radio base station 11 that forms a macro cell C1, with a relatively wide coverage, and radio base stations 12 (12a to 12c) that are placed within the macro cell C1 and that form small cells C2, which are narrower than the macro cell C1. Also, user terminals 20 are placed in the macro cell C1 and in each small cell C2. The arrangement and number of cells and user terminals 20 and so forth are not limited to those illustrated in the drawings.

The user terminals 20 can connect with both the radio base station 11 and the radio base stations 12. The user terminals 20 might use the macro cell C1 and the small cells C2 at the same time by means of CA or DC. Furthermore, the user terminals 20 may apply CA or DC using a plurality of cells (CCs) (for example, five or fewer CCs or six or more CCs).

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the structure of the frequency band for use in each radio base station is by no means limited to these.

Furthermore, the user terminals 20 can communicate by using time division duplexing (TDD) and/or frequency division duplexing (FDD), in each cell. Furthermore, in each cell (carrier), a single numerology may be used, or a plurality of different numerologies may be used.

A numerology may refer to a communication parameter that is applied to transmission and/or receipt of a given signal and/or channel, and represent at least one of the subcarrier spacing, the bandwidth, the duration of symbols, the length of cyclic prefixes, the duration of subframes, the length of TTIs, the number of symbols per TTI, the radio frame configuration, the filtering process, the windowing process, and so on.

The radio base station 11 and a radio base station 12 (or two radio base stations 12) may be connected with each other by cables (for example, by optical fiber, which is in compliance with the Common Public Radio Interface (CPRI), the X2 interface and so on), or by radio.

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but these are by no means limiting. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNodeB (eNB),” a “transmitting/receiving point” and so on. Also, the radio base stations 12 are radio base stations each having a local coverage, and may be referred to as “small base stations,” “micro base stations,” “pico base stations,” “femto base stations,” “Home eNodeBs (HeNBs),” “Remote Radio Heads (RRHs),” “transmitting/receiving points” and so on. Hereinafter, the radio base stations 11 and 12 will be collectively referred to as “radio base stations 10,” unless specified otherwise.

The user terminals 20 are terminals that support various communication schemes such as LTE, LTE-A and so on, and may be either mobile communication terminals (mobile stations) or stationary communication terminals (fixed stations).

In the radio communication system 1, as radio access schemes, orthogonal frequency division multiple access (OFDMA) is applied to the downlink, and single-carrier frequency division multiple access (SC-FDMA) and/or OFDMA are applied to the uplink.

OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands that are each formed with one or contiguous resource blocks, per terminal, and allowing a plurality of terminals to use mutually different bands. Note that the uplink and downlink radio access schemes are not limited to the combinations of these, and other radio access schemes may be used as well.

In the radio communication system 1, a downlink shared channel (Physical Downlink Shared CHannel (PDSCH)), which is used by each user terminal 20 on a shared basis, a broadcast channel (Physical Broadcast CHannel (PBCH)), downlink L1/L2 control channels and so on are used as downlink channels. User data, higher layer control information, System Information Blocks (SIBs) and so on are communicated in the PDSCH. Also, the Master Information Blocks (MIBs) is communicated in the PBCH.

The L1/L2 control channels include at least one of DL control channels (such as a Physical Downlink Control CHannel (PDCCH) and/or an Enhanced Physical Downlink Control CHannel (EPDCCH)), a Physical Control Format Indicator CHannel (PCFICH), and a Physical Hybrid-ARQ Indicator CHannel (PHICH). Downlink control information (DCI), which includes PDSCH and/or PUSCH scheduling information and so on, is communicated by the PDCCH.

Note that scheduling information may be reported in DCI. For example, the DCI to schedule receipt of DL data may be referred to as “DL assignment,” and the DCI to schedule transmission of UL data may also be referred to as “UL grant.”

The number of OFDM symbols to use for the PDCCH is communicated by the PCFICH. Hybrid Automatic Repeat reQuest (HARQ) delivery acknowledgment information (also referred to as, for example, “retransmission control information,” “HARQ-ACKs,” “ACK/NACKs,” etc.) in response to the PUSCH is transmitted by the PHICH. The EPDCCH is frequency-division-multiplexed with the PDSCH (downlink shared data channel) and used to communicate DCI and so on, like the PDCCH.

In the radio communication system 1, an uplink shared channel (Physical Uplink Shared CHannel (PUSCH)), which is used by each user terminal 20 on a shared basis, an uplink control channel (Physical Uplink Control CHannel (PUCCH)), a random access channel (Physical Random Access CHannel (PRACH)) and so on are used as uplink channels. User data, higher layer control information and so on are communicated by the PUSCH. Also, in the PUCCH, downlink radio quality information (Channel Quality Indicator (CQI)), delivery acknowledgment information, scheduling requests (SRs) and so on are communicated. By means of the PRACH, random access preambles for establishing connections with cells are communicated.

In the radio communication system 1, cell-specific reference signals (CRSs), channel state information reference signals (CSI-RSs), demodulation reference signals (DMRSs), positioning reference signals (PRSs) and so on are communicated as downlink reference signals. Also, in the radio communication system 1, measurement reference signals (Sounding Reference Signals (SRSs)), demodulation reference signals (DMRSs) and so on are communicated as uplink reference signals. Note that the DMRSs may be referred to as “user terminal-specific reference signals (UE-specific reference signals).” Also, the reference signals to be communicated are by no means limited to these.

In the radio communication system 1, synchronization signals (for example, Primary Synchronization Signal (PSS)/Secondary Synchronization Signal (SSS)), a broadcast channel (Physical Broadcast CHannel (PBCH)) and so forth are communicated. Note that the synchronization signals and the PBCH may be transmitted in synchronization signal blocks (SSBs).

(Radio Base Station)

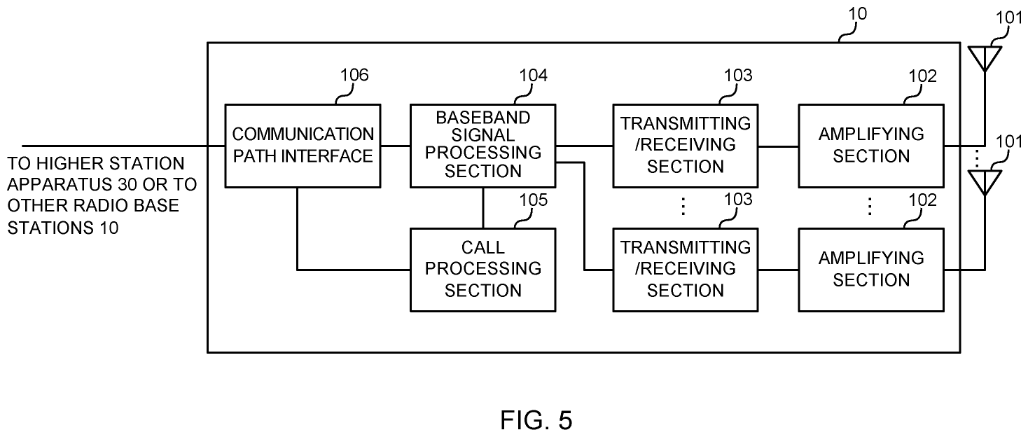

FIG. 5 is a diagram to show an exemplary overall structure of a radio base station according to an embodiment. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30, to the baseband signal processing section 104, via the communication path interface 106.

In the baseband signal processing section 104, the user data is subjected to transmission processes, including a Packet Data Convergence Protocol (PDCP) layer process, user data division and coupling, Radio Link Control (RLC) layer transmission processes such as RLC retransmission control, Medium Access Control (MAC) retransmission control (for example, an Hybrid Automatic Repeat reQuest (HARQ) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base station 10, and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (which is, for example, optical fiber that is in compliance with the Common Public Radio Interface (CPRI), the X2 interface, etc.).

Note that the transmitting/receiving sections 103 may furthermore have an analog beamforming section where analog beamforming takes place. The analog beamforming section may be constituted by an analog beamforming circuit (for example, a phase shifter, a phase shifting circuit, etc.) or analog beamforming apparatus (for example, a phase shifting device) that can be described based on general understanding of the technical field to which the present invention pertains. Furthermore, the transmitting/receiving antennas 101 may be constituted by, for example, array antennas. In addition, the transmitting/receiving sections 103 are designed so that single-BF or multiple-BF operations are applicable.

The transmitting/receiving sections 103 may transmit signals by using transmitting beams, or receive signals by using receiving beams. Transmitting/receiving sections 103 may transmit and/or receive signals by using predetermined beams determined by control section 301.

The transmitting/receiving sections 103 may transmit UL grants. The transmitting/receiving sections 103 may receive various pieces of information described in each of the examples above, from the user terminal 20, or transmit these to the user terminal 20. For example, the transmitting/receiving sections 103 may transmit information related to resources for rate matching/puncturing, information related to mapping patterns for rate matching/puncturing, β_{Offset} and so forth, to the user terminal 20.

The transmitting/receiving sections 103 may receive UCI.

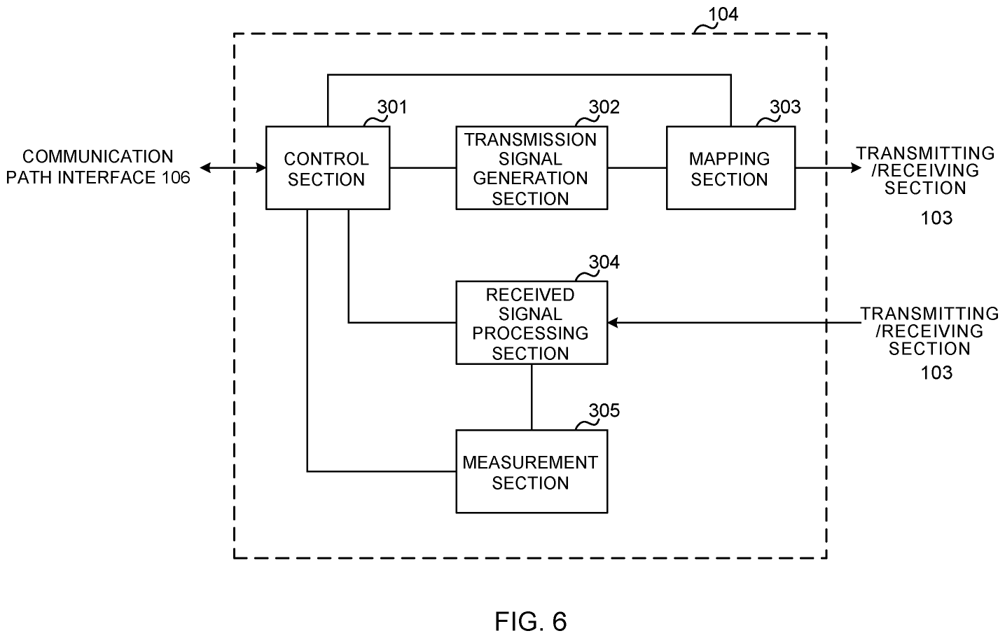

FIG. 6 is a diagram to show an exemplary functional structure of a radio base station according to an embodiment. Note that, although this example primarily shows functional blocks that pertain to characteristic parts of an embodiment, the radio base station 10 might have other functional blocks that are necessary for radio communication as well.

The baseband signal processing section 104 at least has a control section (scheduler) 301, a transmission signal generation section 302, a mapping section 303, a received signal processing section 304 and a measurement section 305. Note that these configurations have only to be included in the radio base station 10, and some or all of these configurations may not be included in the baseband signal processing section 104.

The control section (scheduler) 301 controls the whole of the radio base station 10. The control section 301 can be constituted by a controller, a control circuit or control apparatus that can be described based on general understanding of the technical field to which the present invention pertains.

The control section 301 controls, for example, generation of signals in the transmission signal generation section 302, allocation of signals in the mapping section 303, and so on. Furthermore, the control section 301 controls signal receiving processes in the received signal processing section 304, measurements of signals in the measurement section 305, and so on.

The control section 301 controls the scheduling (for example, resource allocation) of system information, downlink data signals (for example, signals transmitted in the PDSCH), and downlink control signals (for example, signals transmitted in the PDCCH and/or the EPDCCH, such as delivery acknowledgment information). Also, the control section 301 controls the generation of downlink control signals, downlink data signals, and so on based on the results of deciding whether or not retransmission control is necessary for uplink data signals, and so on.

The control section 301 controls scheduling of synchronization signals (for example, PSS/SSS), downlink reference signals (for example, CRS, CSI-RS, DMRS, etc.) and the like.

The control section 301 may exert control so that transmitting beams and/or receiving beams are formed by using digital BF (for example, precoding) in the baseband signal processing section 104 and/or analog BF (for example, phase rotation) in the transmitting/receiving sections 103.

The control section 301 may exert control so that, based on the timing a transmission command (for example, a UL grant) for an uplink shared channel (for example, PUSCH) is received in the user terminal 20, a depuncturing process and/or a rate dematching process are applied to received uplink data.

When there is uplink control information (for example, HARQ-ACK) in response to downlink data received by the user terminal 20 before the timing a UL grant is received, the control section 301 may apply the rate dematching process to the uplink data.

If there is uplink control information in response to downlink data received by the user terminal 20 after the timing a UL grant is received, the control section 301 may apply the depuncturing process to the uplink data.

The transmission signal generation section 302 generates downlink signals (downlink control signals, downlink data signals, downlink reference signals, and so on) based on commands from the control section 301, and outputs these signals to the mapping section 303. The transmission signal generation section 302 can be constituted by a signal generator, a signal generating circuit or signal generating apparatus that can be described based on general understanding of the technical field to which the present invention pertains.

For example, the transmission signal generation section 302 generates DL assignments, which report downlink data allocation information, and/or UL grants, which report uplink data allocation information, based on commands from the control section 301. DL assignments and UL grants are both DCI, in compliance with DCI format. Also, the downlink data signals are subjected to the coding process, the modulation process and so on, by using coding rates, modulation schemes and the like that are determined based on, for example, channel state information (CSI) from each user terminal 20.

The mapping section 303 maps the downlink signals generated in the transmission signal generation section 302 to predetermined radio resources based on commands from the control section 301, and outputs these to the transmitting/receiving sections 103. The mapping section 303 can be constituted by a mapper, a mapping circuit or mapping apparatus that can be described based on general understanding of the technical field to which the present invention pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminal 20 (uplink control signals, uplink data signals, uplink reference signals, etc.). The received signal processing section 304 can be constituted by a signal processor, a signal processing circuit or signal processing apparatus that can be described based on general understanding of the technical field to which the present invention pertains.

The received signal processing section 304 outputs the decoded information acquired through the receiving processes, to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signals. The measurement section 305 can be constituted by a measurer, a measurement circuit or measurement apparatus that can be described based on general understanding of the technical field to which the present invention pertains.

For example, the measurement section 305 may perform Radio Resource Management (RRM) measurements, Channel State Information (CSI) measurements, and so on, based on the received signals. The measurement section 305 may measure the received power (for example, Reference Signal Received Power (RSRP)), the received quality (for example, Reference Signal Received Quality (RSRQ), Signal to Interference plus Noise Ratio (SINR), Signal to Noise Ratio (SNR), etc.), the signal strength (for example, Received Signal Strength Indicator (RSSI)), transmission path information (for example, CSI) and so on. The measurement results may be output to the control section 301.

(User Terminal)

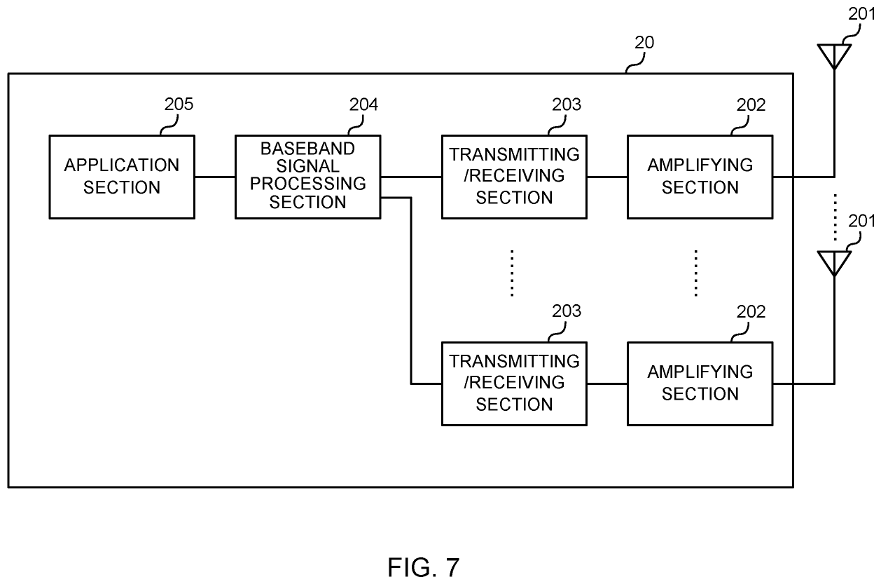

FIG. 7 is a diagram to show an exemplary overall structure of a user terminal according to an embodiment. A user terminal 20 has a plurality of transmitting/receiving antennas 201, amplifying sections 202, transmitting/receiving sections 203, a baseband signal processing section 204, and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present invention pertains. Note that a transmitting/receiving section 203 may be structured as a transmitting/receiving section in one entity, or may be constituted by a transmitting section and a receiving section.

The baseband signal processing section 204 performs, for the baseband signal that is input, an FFT process, error correction decoding, a retransmission control receiving process, and so on. Downlink user data is forwarded to the application section 205. The application section 205 performs processes related to higher layers above the physical layer and the MAC layer, and so on. Also, in the downlink data, the broadcast information can be also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving sections 203.

Baseband signals that are output from the baseband signal processing section 204 are converted into a radio frequency band in the transmitting/receiving sections 203, and transmitted. The radio frequency signals that are subjected to frequency conversion in the transmitting/receiving sections 203 are amplified in the amplifying sections 202, and transmitted from the transmitting/receiving antennas 201.

Note that the transmitting/receiving sections 203 may further have an analog beamforming section where analog beamforming takes place. The analog beamforming section may be constituted by an analog beamforming circuit (for example, a phase shifter, a phase shifting circuit, etc.) or analog beamforming apparatus (for example, a phase shifting device) that can be described based on general understanding of the technical field to which the present invention pertains. Furthermore, the transmitting/receiving antennas 201 may be constituted by, for example, array antennas. In addition, the transmitting/receiving sections 203 are structured so that single-BF and multiple-BF can be used.

The transmitting/receiving sections 203 may transmit signals by using transmitting beams, or receive signals by using receiving beams. The transmitting/receiving sections 203 may transmit and/or receive signals by using predetermined beams selected by the control section 401.

The transmitting/receiving sections 203 may receive various pieces of information described in each of the examples above, from the radio base station 10, and/or transmit these to the radio base station 10. For example, the transmitting/receiving sections 103 may receive information related to resources for rate matching/puncturing, information related to mapping patterns for rate matching/puncturing, β_{Offset} and so forth, from the radio base station 10.

The transmitting/receiving sections 203 may transmit UCI.

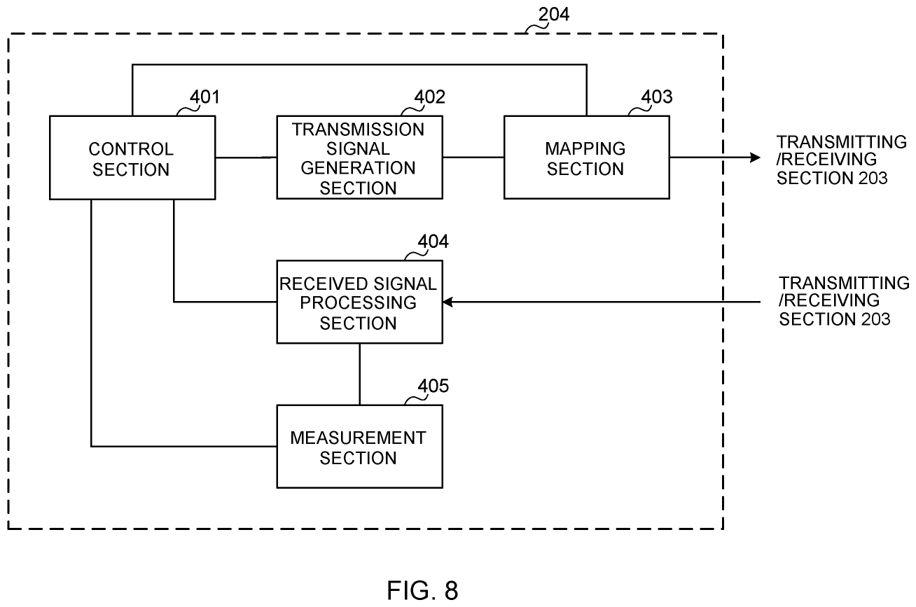

FIG. 8 is a diagram to show an exemplary functional structure of a user terminal according to an embodiment. Note that, although this example primarily shows functional blocks that pertain to characteristic parts of an embodiment, the user terminal 20 might have other functional blocks that are necessary for radio communication as well.

The baseband signal processing section 204 provided in the user terminal 20 at least has a control section 401, a transmission signal generation section 402, a mapping section 403, a received signal processing section 404, and a measurement section 405. Note that these configurations have only to be included in the user terminal 20, and some or all of these configurations may not be included in the baseband signal processing section 204.

The control section 401 controls the whole of the user terminal 20. The control section 401 can be constituted by a controller, a control circuit or control apparatus that can be described based on general understanding of the technical field to which the present invention pertains.

The control section 401 controls, for example, generation of signals in the transmission signal generation section 402, allocation of signals in the mapping section 403, and so on. Furthermore, the control section 401 controls signal receiving processes in the received signal processing section 404, measurements of signals in the measurement section 405, and so on.

The control section 401 acquires the downlink control signals and downlink data signals transmitted from the radio base station 10, via the received signal processing section 404. The control section 401 controls the generation of uplink control signals and/or uplink data signals based on results of deciding whether or not retransmission control is necessary for the downlink control signals and/or downlink data signals, and so on.

The control section 401 may exert control so that transmitting beams and/or receiving beams are formed by using digital BF (for example, precoding) in the baseband signal processing section 204 and/or by using analog BF (for example, phase rotation) in the transmitting/receiving sections 203.

The control section 401 may exert control so that, based on the timing a transmission command (for example, a UL grant) for an uplink shared channel (for example, PUSCH) is received, a puncturing process and/or a rate matching process are applied to uplink data.

When there is uplink control information (for example, HARQ-ACK) in response to downlink data received before the timing a UL grant is received, the control section 401 may apply the rate matching process to the uplink data.

If there is uplink control information in response to downlink data received after the timing a UL grant is received, the control section 401 may apply the puncturing process to the uplink data.

In addition, when various pieces of information reported from the radio base station 10 are acquired from the received signal processing section 404, the control section 401 may update the parameters used for control based on the information.

The transmission signal generation section 402 generates uplink signals (uplink control signals, uplink data signals, uplink reference signals, etc.) based on commands from the control section 401, and outputs these signals to the mapping section 403. The transmission signal generation section 402 can be constituted by a signal generator, a signal generating circuit, or signal generation apparatus that can be described based on general understanding of the technical field to which the present invention pertains.

For example, the transmission signal generation section 402 generates uplink control signals such as delivery acknowledgement information, channel state information (CSI) and so on, based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and outputs these to the transmitting/receiving sections 203. The mapping section 403 can be constituted by a mapper, a mapping circuit or mapping apparatus that can be described based on general understanding of the technical field to which the present invention pertains.

The received signal processing section 404 performs receiving processes (for example, demapping, demodulation, decoding and so on) for received signals that are input from the transmitting/receiving sections 203. Here, the received signals include, for example, downlink signals (downlink control signals, downlink data signals, downlink reference signals, and so on) that are transmitted from the radio base station 10. The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present disclosure.

The received signal processing section 404 outputs the decoded information acquired through the receiving processes, to the control section 401. The received signal processing section 404 outputs, for example, broadcast information, system information, RRC signaling, DCI and so on, to the control section 401. Also, the received signal processing section 404 outputs the received signals and/or the signals after the receiving processes to the measurement section 405.

The measurement section 405 conducts measurements with respect to the received signals. The measurement section 405 can be constituted by a measurer, a measurement circuit or measurement apparatus that can be described based on general understanding of the technical field to which the present invention pertains.

For example, the measurement section 405 may perform RRM measurements, CSI measurements, and so on, based on the received signals. The measurement section 405 may measure the received power (for example, RSRP), the received quality (for example, RSRQ, SINR, SNR, etc.), the signal strength (for example, RSSI), transmission path information (for example, CSI), and so on. The measurement results may be output to the control section 401.

(Hardware Structure)

Note that the block diagrams that have been used to describe the above embodiment show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically-separate pieces of apparatus (by using cables and/or radio, for example) and using these multiple pieces of apparatus.

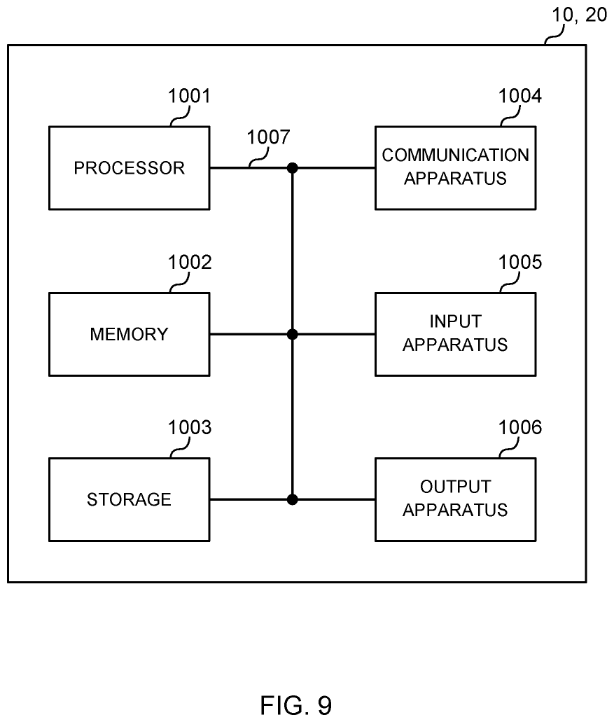

For example, the radio base station, user terminals, and so on according to an embodiment may function as a computer that executes the processes of each example of the embodiment. FIG. 9 is a diagram to show an exemplary hardware structure of a radio base station and a user terminal according to an embodiment. Physically, the above-described radio base stations 10 and user terminals 20 may be formed as a computer apparatus that includes a processor 1001, a memory 1002, a storage 1003, communication apparatus 1004, input apparatus 1005, output apparatus 1006, a bus 1007 and so on.

Note that, in the following description, the term “apparatus” may be replaced by “circuit,” “device,” “unit” and so on. Note that, the hardware structure of a radio base station 10 and a user terminal 20 may be designed to include one or more of each apparatus shown in the drawings, or may be designed not to include part of the apparatus.

For example, although only one processor 1001 is shown, a plurality of processors may be provided. Furthermore, processes may be implemented with one processor, or processes may be implemented simultaneously or in sequence, or by using different techniques, on one or more processors. Note that the processor 1001 may be implemented with one or more chips.

The functions of the radio base station 10 and the user terminal 20 are implemented by, for example, allowing hardware such as the processor 1001 and the memory 1002 to read predetermined software (programs), and allowing the processor 1001 to do calculations, control communication that involves the communication apparatus 1004, control the reading and/or writing of data in the memory 1002 and the storage 1003, and so on.

The processor 1001 may control the whole computer by, for example, running an operating system. The processor 1001 may be constituted by a central processing unit (CPU), which includes interfaces with peripheral apparatus, control apparatus, computing apparatus, a register, and so on. For example, the above-described baseband signal processing section 104 (204), call processing section 105, and so on may be implemented by the processor 1001.

Furthermore, the processor 1001 reads programs (program codes), software modules, data, and so forth from the storage 1003 and/or the communication apparatus 1004, into the memory 1002, and executes various processes according to these. As for the programs, programs to allow computers to execute at least part of the operations of the above-described detailed description of the preferred embodiment may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus),” and so on. The memory 1002 can store executable programs (program codes), software modules, and so on for implementing the radio communication method according to an embodiment.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) or the like), a digital versatile disc, a Blu-ray (registered trademark) disk, etc.), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using cable and/or wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer and so on, in order to implement, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from outside (for example, a keyboard, a mouse, a microphone, a switch, a button, a sensor and so on). The output apparatus 1006 is an output device for allowing sending output to outside (for example, a display, a speaker, an LED (Light Emitting Diode) lamp, and so on). Note that the input apparatus 1005 and the output apparatus 1006 may be provided in an integrated structure (for example, a touch panel).

Furthermore, these pieces of apparatus, including the processor 1001, the memory 1002 and so on, are connected by the bus 1007, so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an Application-Specific Integrated Circuit (ASIC), a Programmable Logic Device (PLD), an Field Programmable Gate Array (FPGA) and so on, and part or all of the functional blocks may be implemented by these pieces of hardware. For example, the processor 1001 may be implemented with at least one of these pieces of hardware.

(Variations)

Note that, the terminology used in this specification and the terminology that is needed to understand this specification may be replaced by other terms that communicate the same or similar meanings. For example, a “channel” and/or a “symbol” may be replaced by a “signal” (or “signaling”). Also, a “signal” may be a “message.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency,” and so on.

Furthermore, a radio frame may be comprised of one or more periods (frames) in the time domain. One or more periods (frames) that constitute a radio frame may be each referred to as a “subframe.” Furthermore, a subframe may be comprised of one or multiple slots in the time domain. A subframe may be a fixed time duration (for example, 1 ms), which does not depend on numerology.

Furthermore, a slot may be comprised of one or more symbols in the time domain (Orthogonal Frequency Division Multiplexing (OFDM) symbols, Single Carrier Frequency Division Multiple Access (SC-FDMA) symbols, and so on). Also, a slot may be a time unit based on numerology. Also, a slot may include a plurality of minislots. Each minislot may be comprised of one or more symbols in the time domain. Also, a minislot may be referred to as a “subslot.”

A radio frame, a subframe, a slot, a minislot, and a symbol all refer to a unit of time in signal communication. A radio frame, a subframe, a slot, a minislot and a symbol may be each called by other applicable names. For example, one subframe may be referred to as a “transmission time interval (TTI),” or a plurality of consecutive subframes may be referred to as a “TTI,” or one slot or one minislot may be referred to as a “TTI.” That is, a subframe and/or a TTI may be a subframe (1 ms) in existing LTE, may be a shorter period than 1 ms (for example, one to thirteen symbols), or may be a longer period of time than 1 ms. Note that the unit to represent a TTI may be referred to as a “slot,” a “minislot” and so on, instead of a “subframe.”

Here, a TTI refers to the minimum time unit for scheduling in radio communication, for example. For example, in LTE systems, a radio base station schedules the radio resources (such as the frequency bandwidth and transmission power each user terminal can use) to allocate to each user terminal in TTI units. Note that the definition of TTIs is not limited to this.

A TTI may be the transmission time unit of channel-encoded data packets (transport blocks), code blocks and/or codewords, or may be the unit of processing in scheduling, link adaptation, and so on. Note that, when a TTI is given, the period of time (for example, the number of symbols) in which transport blocks, code blocks and/or codewords are actually mapped may be shorter than the TTI.

Note that, when one slot or one minislot is referred to as a “TTI,” one or more TTIs (that is, one or multiple slots or one or more minislots) may be the minimum time unit of scheduling. Also, the number of slots (the number of minislots) to constitute this minimum time unit for scheduling may be controlled.

A TTI having a time length of 1 ms may be referred to as a “normal TTI” (TTI in LTE Rel. 8 to 12), a “long TTI,” a “normal subframe,” a “long subframe,” and so on. A TTI that is shorter than a normal TTI may be referred to as a “shortened TTI,” a “short TTI,” a “partial TTI (or a “fractional TTI”),” a “shortened subframe,” a “short subframe,” a “minislot,” a “sub-slot,” and so on.

Note that a long TTI (for example, a normal TTI, a subframe, etc.) may be replaced with a TTI having a time duration exceeding 1 ms, and a short TTI (for example, a shortened TTI) may be replaced with a TTI having a TTI length less than the TTI length of a long TTI and not less than 1 ms.

A resource block (RB) is the unit of resource allocation in the time domain and the frequency domain, and may include one or a plurality of consecutive subcarriers in the frequency domain. Also, an RB may include one or more symbols in the time domain, and may be one slot, one minislot, one subframe or one TTI in length. One TTI and one subframe each may be comprised of one or more resource blocks. Note that one or more RBs may be referred to as a “physical resource block (Physical RB (PRB)),” a “subcarrier group (SCG),” a “resource element group (REG),” a “PRB pair,” an “RB pair,” and so on.

Furthermore, a resource block may be comprised of one or more resource elements (REs). For example, one RE may be a radio resource field of one subcarrier and one symbol.

Note that the structures of radio frames, subframes, slots, minislots, symbols, and so on described above are simply examples. For example, configurations pertaining to the number of subframes included in a radio frame, the number of slots included in a subframe or a radio frame, the number of minislots included in a slot, the number of symbols and RBs included in a slot or a minislot, the number of subcarriers included in an RB, the number of symbols in a TTI, the symbol duration, the length of cyclic prefixes (CPs), and so on can be variously changed.

Also, the information and parameters described in this specification may be represented in absolute values or in relative values with respect to predetermined values, or may be represented using other applicable information. For example, a radio resource may be indicated by a predetermined index.

The names used for parameters and so on in this specification are in no respect limiting. For example, since various channels (Physical Uplink Control CHannel (PUCCH), Physical Downlink Control CHannel (PDCCH) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers, and/or from lower layers to higher layers. Information, signals, and so on may be input and/or output via a plurality of network nodes.

The information, signals, and so on that are input and/or output may be stored in a specific location (for example, in a memory), or may be managed in a control table. The information, signals, and so on to be input and/or output can be overwritten, updated, or appended. The information, signals, and so on that are output may be deleted. The information, signals, and so on that are input may be transmitted to other pieces of apparatus.

Reporting of information is by no means limited to the examples/embodiments described in this specification, and other methods may be used as well. For example, reporting of information may be implemented by using physical layer signaling (for example, downlink control information (DCI), uplink control information (UCI)), higher layer signaling (for example, Radio Resource Control (RRC) signaling, broadcast information (the master information block (MIB), system information blocks (SIBs) and so on), Medium Access Control (MAC) signaling, etc.), and other signals and/or combinations of these.

Note that physical layer signaling may be referred to as “L1/L2 (Layer 1/Layer 2) control information (L1/L2 control signals),” “L1 control information (L1 control signal),” and so on. Also, RRC signaling may be referred to as “RRC messages,” and can be, for example, an “RRC connection setup message,” “RRC connection reconfiguration message,” and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent in an implicit way (for example, by not reporting this piece of information, by reporting another piece of information, and so on).

Decisions may be made in values represented by one bit (0 or 1), may be made in Boolean values that represent true or false, or may be made by comparing numerical values (for example, comparison against a predetermined value).

Software, whether referred to as “software,” “firmware,” “middleware,” “microcode,” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions, and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on), and/or wireless technologies (infrared radiation, microwaves, and so on), these wired technologies and/or wireless technologies are also included in the definition of communication media.

The terms “system” and “network” as used herein are used interchangeably.

As used herein, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell,” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

As used herein, the terms “mobile station (MS),” “user terminal,” “user equipment (UE),” and “terminal” may be used interchangeably.

A mobile station may be referred to, by a person skilled in the art, as a “subscriber station,” “mobile unit,” “subscriber unit,” “wireless unit,” “remote unit,” “mobile device,” “wireless device,” “radio communication device,” “remote device,” “mobile subscriber station,” “access terminal,” “mobile terminal,” “wireless terminal,” “remote terminal,” “handset,” “user agent,” “mobile client,” “client,” or some other suitable terms.

Furthermore, the radio base stations in this specification may be interpreted as user terminals. For example, the examples/embodiments of the present disclosure may be applied to a configuration in which communication between a radio base station and a user terminal is replaced with communication among a plurality of user terminals (D2D (Device-to-Device)). In this case, user terminals 20 may have the functions of the radio base stations 10 described above. In addition, terms such as “uplink” and “downlink” may be interpreted as “side.” For example, an “uplink channel” may be interpreted as a “side channel.”

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by their upper nodes. In a network comprised of one or more network nodes with base stations, it is clear that various operations that are performed so as to communicate with terminals can be performed by base stations, one or more network nodes (for example, MMEs (Mobility Management Entities), S-GWs (Serving-Gateways), and so on may be possible, but these are not limiting) other than base stations, or combinations of these.

The examples/embodiments illustrated in this specification may be used individually or in combinations, which may be switched depending on the mode of implementation. Also, the order of processes, sequences, flowcharts, and so on that have been used to describe the examples/embodiments herein may be re-ordered as long as inconsistencies do not arise. For example, although various methods have been illustrated in this specification with various components of steps in exemplary orders, the specific orders that are illustrated herein are by no means limiting.

The examples/embodiments illustrated in this specification may be applied to systems that use Long-Term Evolution (LTE), LTE-Advanced (LTE-A), LTE-Beyond (LTE-B), SUPER 3G, IMT-Advanced, 4th generation mobile communication system (4G), 5th generation mobile communication system (5G), Future Radio Access (FRA), New-RAT (Radio Access Technology), New Radio (NR), New radio access (NX), Future generation radio access (FX), GSM (registered trademark) (Global System for Mobile communications), CDMA2000, Ultra Mobile Broadband (UMB), IEEE 802.11 (Wi-Fi (registered trademark)), IEEE 802.16 (WiMAX (registered trademark)), IEEE 802.20, Ultra-WideB and (UWB), Bluetooth (registered trademark), other adequate radio communication methods, and/or next-generation systems that are enhanced based on these.

The phrase “based on” as used in this specification does not mean “based only on” unless otherwise specified. In other words, the phrase “based on” means both “based only on” and “based at least on.”

Reference to elements with designations such as “first,” “second,” and so on as used herein does not generally limit the number/quantity or order of these elements. These designations are used herein only for convenience, as a method for distinguishing between two or more elements. In this way, reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database, or some other data structure), ascertaining, and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing, and so on. In other words, to “judge” and “determine” as used herein may be interpreted to mean making judgements and determinations related to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be interpreted as “access.”

As used herein, when two elements are connected, these elements may be considered “connected” or “coupled” to each other by using one or more electrical wires, cables, and/or printed electrical connections, and, as a number of non-limiting and non-inclusive examples, by using electromagnetic energy having wavelengths of the radio frequency region, the microwave region and/or the optical region (both visible and invisible).

In the present specification, the phrase “A and B are different” may mean “A and B are different from each other.” The terms such as “leave,” “coupled” and the like may be interpreted as well.

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

(Supplementary Notes)

Now, supplementary notes on the present disclosure will follow below.

[Configuration 1]

A user terminal having a receiving section that receives a transmission command for an uplink shared channel, a transmitting section that transmits uplink data and uplink control information in the uplink shared channel, and a control section that exerts control so that a puncturing process and/or a rate matching process is applied to the uplink data based on a timing the transmission command is received.

[Configuration 2]

The user terminal according to configuration 1, in which, when there is uplink control information in response to downlink data received before the timing the transmission command is received, the control section applies the rate matching process to the uplink data.

[Configuration 3]

The user terminal according to configuration 1 or 2, in which, when there is uplink control information in response to downlink data received after the timing the transmission command is received, the control section applies the puncturing process to the uplink data.

[Configuration 4]

A radio communication method including the steps of receiving a transmission command for an uplink shared channel, transmitting uplink data and uplink control information in the uplink shared channel, and exerting control so that a puncturing process and/or a rate matching process is applied to the uplink data based on a timing the transmission command is received.

The disclosure of Japanese Patent Application No. 2017-196410, filed on Sep. 20, 2017, including the specification, drawings and abstract, is incorporated herein by reference in its entirety.

1. A user terminal comprising:
a receiving section that receives a transmission command for an uplink shared channel;
a transmitting section that transmits uplink data and uplink control information in the uplink shared channel; and
a control section that exerts control so that a puncturing process and/or a rate matching process is applied to the uplink data based on a timing the transmission command is received.

2. The user terminal according to claim 1, wherein, when there is uplink control information in response to downlink data received before the timing the transmission command is received, the control section applies the rate matching process to the uplink data.

3. The user terminal according to claim 1, wherein, when there is uplink control information in response to downlink data received after the timing the transmission command is received, the control section applies the puncturing process to the uplink data.

4. A radio communication method comprising the steps of:
receiving a transmission command for an uplink shared channel;
transmitting uplink data and uplink control information in the uplink shared channel; and
exerting control so that a puncturing process and/or a rate matching process is applied to the uplink data based on a timing the transmission command is received.

5. The user terminal according to claim 2, wherein, when there is uplink control information in response to downlink data received after the timing the transmission command is received, the control section applies the puncturing process to the uplink data.
